(19) United States
(12) Patent Application Publication
(10) Pub. No.: US 2021/0234878 A1
(43) Pub. Date: Jul. 29, 2021

(54) METHOD AND SYSTEM TO DETERMINE DEVICE VULNERABILITIES BY SCANNER ANALYSIS

(71) Applicant: CHECK POINT SOFTWARE TECHNOLOGIES LTD., TEL AVIV (IL)

(72) Inventors: Tamara LEIDERFARB, Modiin-Macabim-Reut (IL); Nir NAAMAN, Modiin (IL)

(21) Appl. No.: 17/158,205

(22) Filed: Jan. 26, 2021

Related U.S. Application Data
(60) Provisional application No. 62/965,925, filed on Jan. 26, 2020.

(51) Int. Cl. H04L 29/06

(52) U.S. Cl. CPC H04L 63/1425; H04L 63/0236; H04L 63/20; H04L 63/1433

(57) ABSTRACT

Methods and systems provide a vulnerabilities list and an open devices list based on results from scanning by scanners not associated with a host computer or resource.

### TECHNICAL FIELD

The present invention is directed to determining vulnerabilities in devices along networks.

### BACKGROUND OF THE INVENTION

Vulnerability scanners are constantly running on networks, and seek to fingerprint devices, ports, protocols, to determine their vulnerabilities. Vulnerability scanners are, for example, computer programs designed to assess computers, networks, or applications, for known weaknesses, such as those arising from mis-configurations or flawed programming within a network-based asset such as a firewall, router, web server, or application server.

The results of the scans are typically kept internally or provided to customers. Every resource exposed to the Internet is typically scanned at least once a day, and in many cases hourly, typically by multiple different scanners. Contemporary scanners typically fingerprint the devices, and mark the vulnerability of the each device. It is important to scan all networked devices for vulnerabilities, as many devices, which were neither designed nor intended to be exposed outside of their networks, are ultimately linked to the global Internet, making critical devices and infrastructure available to attackers worldwide.

The scanners themselves are diverse and their purposes and capabilities diverse—but overall, summarizing their results of all of them provides a relatively accurate picture of an enterprise or device's vulnerabilities. Additionally, and more important, the scanners expose vulnerabilities which are already known, or can easily become known.

These scanners provide an overall status of a network, including indicating sensitive locations along the network, rather than providing a specific status for every host or resource in the network. For example, a host can be running an extremely old and vulnerable version of an Operating System, but is very well protected by a firewall in the network, or a very up-to-date anti-virus software package.

### SUMMARY OF THE INVENTION

The present invention provides methods and systems for providing a vulnerabilities list and an open devices list based on results from scanning by scanners not associated with a host computer or resource. The present invention is passive, in that it does not scan, nor even requires direct connectivity to the scan targets. It listens to traffic of a scanning session, extracts features from the traffic of the scanning session, and analyzes the extracted features to determine vulnerabilities in devices along networks, the devices including host computers and the like.

Embodiments of the invention are directed to a method for determining vulnerabilities in devices. The method comprises: listening to traffic, by an inspection server, between a scanner and a host computer; and, analyzing the traffic, by the inspection server, to determine vulnerabilities in the host computer.

Optionally, the method is such that the analyzing the traffic includes determining that the traffic is traffic of a scanning session.

Optionally, the method is such that the analyzing the traffic includes identifying features of the scanning session traffic including, one or more of: protocols; source communication ports; destination communication ports; scanned vulnerabilities; number of bytes sent; number of bytes received; call direction; and, response codes.

Optionally, the method is such that the protocols include communication protocols.

Optionally, the method is such that the analyzing the traffic of the scanning session includes selecting one or more of the identified features from the scanning session traffic.

Optionally, the method is such that the analyzing the traffic of the scanning session additionally comprises: applying an algorithm to the selected one or more identified features to determine whether there are vulnerabilities in the devices.

Optionally, the method is such that the vulnerabilities include known vulnerabilities.

Optionally, the method is such that the devices include host computers.

Embodiments of the invention are directed to a method for detecting the location of vulnerabilities in devices along a network. The method comprises: determining the existence of vulnerabilities in at least one device from the traffic of a scanning session; and, determining the zone direction of the scanner that detected the vulnerability, the zone direction including one of a trusted zone or an untrusted zone.

Optionally, the method is such that the zone direction is determined based on one or more parameters including: Internet Protocol (IP) address of a scanner; network subnet/net range of the scanner; or, knowledge of the network architecture associated with the device being scanned resides in a trusted or untrusted zone.

Optionally, the method is such that if the scanner resides in an untrusted zone, the device being scanned is open to vulnerabilities outside of the trusted zone.

Optionally, the method is such that outside of the trusted zone includes the Internet.

Optionally, the method is such that if the scanner resides in a trusted zone, the device being scanned can be identified as being open to vulnerabilities.

Embodiments of the invention are directed to a system for determining vulnerabilities in devices. The system comprises: a memory; a processor coupled to the memory, the processor programmed with executable instructions to determine whether detected traffic is that of a scanning session and if so, determining vulnerabilities in devices; a listener for listening to the traffic of the scanning session; a feature extractor for extracting features from the traffic of the scanning session; and, a feature aggregator for selecting extracted features and applying an algorithm for the features to detect vulnerabilities in the devices.

Optionally, the system is such that the extracted features include one or more of: protocols; source communication ports; destination communication ports; scanned vulnerabilities; number of bytes sent; number of bytes received; call direction; and, response codes.

Optionally, the system is such that it additionally comprises: a zone direction detector for detecting the zone direction of a scanner associated with the scanning session for the traffic.

Optionally, the system is such that the zone direction detector analyzes parameters including one or more of: the Internet Protocol (IP) address of the scanner, network subnet/net range of the scanner, or, previous knowledge of the specific network architecture of where the device being scanned resides.

This document references terms that are used consistently or interchangeably herein. These terms, including variations thereof, are as follows:

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smart phone, personal digital assistant (PDA), mobile telephone or cellular telephone).

A “server” is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1A is a diagram of an exemplary environment for the invention;

FIG. 1B is a block diagram of an example architecture for the inspection servers of FIG. 1;

FIG. 2, formed of FIGS. 2A and 2B, is a flow diagram detailing processes in accordance with embodiments of the invention; and,

FIG. 3 is an example threat map produced as a result of the processes of FIG. 2.

### DETAILED DESCRIPTION OF THE INVENTION

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

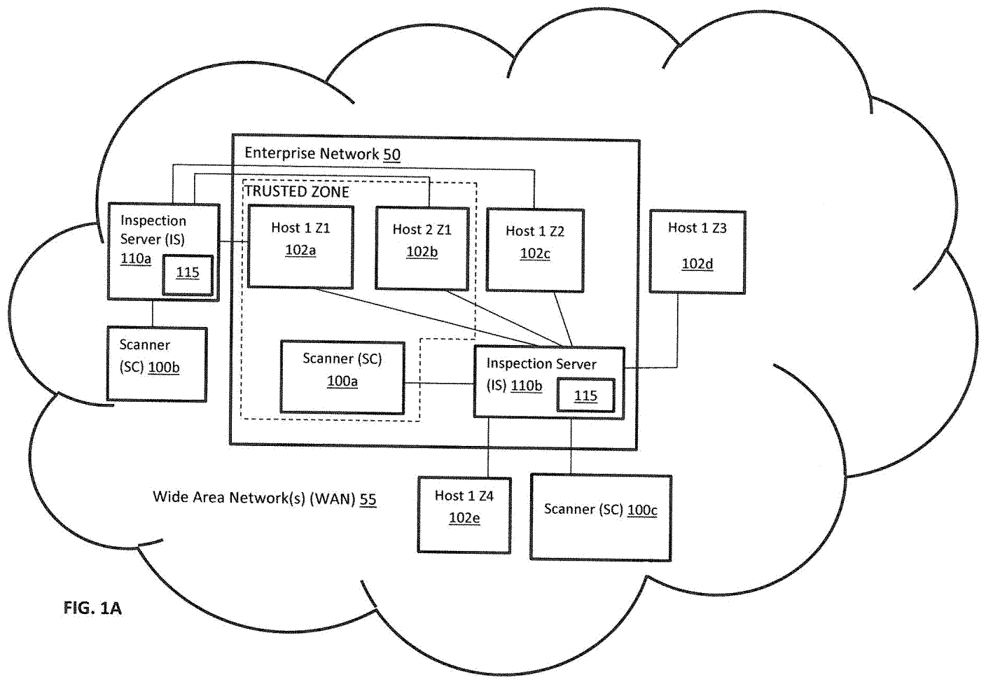

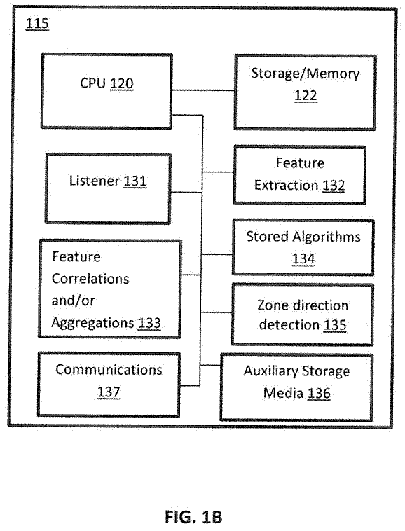

FIG. 1A shows an example environment in which the invention operates, where scanners (SC) 100a (within an enterprise network 50) and scanners 100b, 100c (outside of the enterprise network 50 and within a wide area network 55, such as the Internet), and are continuously attempting to scan host computers (H), for example, the host computer 102a 102b in a first zone, or Zone 1 (Z1), and host computers 102c, in a second zone, or Zone 2 (Z2), 102d in third zone (Z3), and 102e in a fourth zone (Z4). Inspection servers (IS) 110a, 110b, shown as including a system 115, are positioned intermediate the host computers 102a, 102b, 102c, 102d and 102e and the scanners 100a, 100b, 100c, to listen for traffic, either internal or span or tap inline, between the host computers and the scanners to determine vulnerabilities in the host computers. Zone 1 with its host computers 102a, 102b and scanner 100a, are in a trusted zone. All other scanners 100b, 100c, host computers 102c, 102d, 102e, are in untrusted zones. For example, a trusted zone, shown by the broken line area of FIG. 1A, may be a zone that is relied upon to a specified extent to enforce a specified security policy. When a general reference is made to the scanners (SC), element number 100 is used, for the host computers (H), element number 102 is used, and for the inspection servers (IS), element number 110 is used.

FIG. 1B shows an example architecture for a system 115 of the invention, as found, for example, in an inspection server 110. The system 115 includes multiple components in hardware and/or software, the most germane components are discussed here. While the system 115 is shown in an inspection server 110, the system 115 components do not all have to be in the inspection server 115, and may be external to the inspection server 115 and linked thereto.

The system 115 includes processors in a central processing unit (CPU) 120 linked to storage/memory 122. The CPU 120 is in turn, linked to components such as a listener or sniffer 131, a feature extractor 132, feature correlation and/or aggregation 133, storage media including algorithms for determining vulnerabilities 134, a zone direction detection module 135, and auxiliary storage media 136, and, a communications module 137. While these components 120, 122 and 131-137 are the most germane to the system 115, other components are permissible. “Linked” as used herein, includes both wired and/or wireless links, either direct or indirect, such that the components 120, 122, 131-137 are in electronic and/or data communications with each other, either directly or indirectly. As used herein, a “module”, for example, includes a component for storing instructions (e.g., machine readable instructions) for performing one or more processes, and including or associated with processors, e.g., the CPU 120, for executing the instructions.

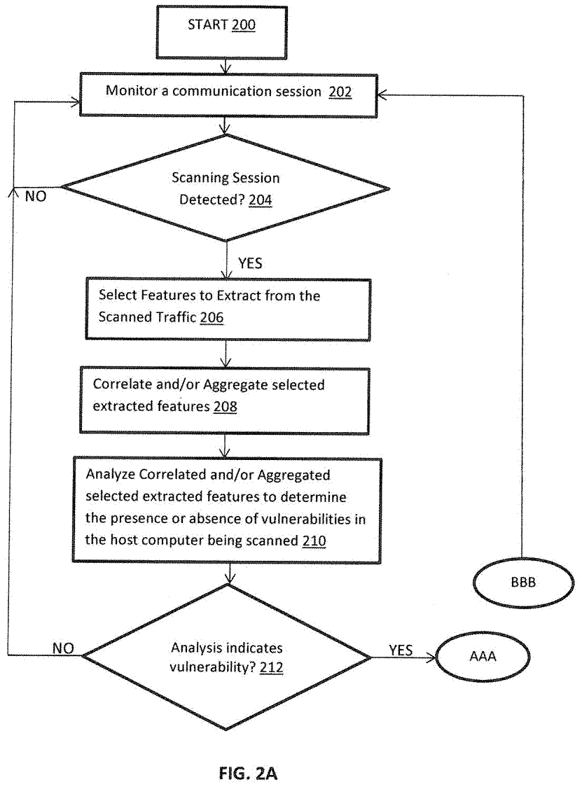

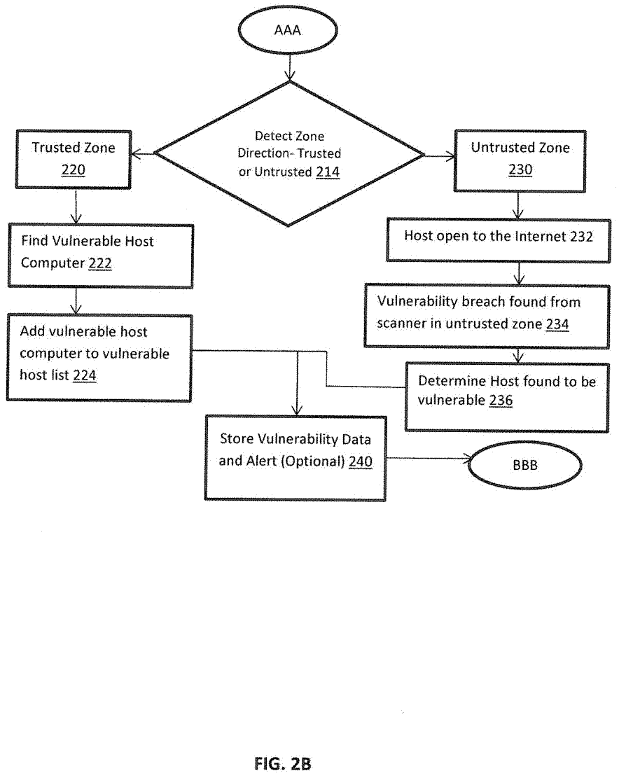

The CPU 102 is formed of one or more processors, including hardware processors, and performs the processes (methods) of the invention, including analyzing the traffic (and traffic data) being listened to, in order to determine vulnerabilities in the host computers 102a-102c, for example, by performing the process of FIGS. 2A and 2B, collectively FIG. 2, which is detailed below. The processes of FIG. 2 may be in the form of programs, algorithms and the like. For example, the processors of the CPU 120 may include x86 Processors from AMD (Advanced Micro Devices) and Intel, Xenon® and Pentium® processors from Intel, as well as any combinations thereof.

The storage/memory 122 stores machine-executable instructions executed by the CPU 120 for performing the processes of the invention (e.g., as shown in FIG. 2). The storage/memory 124, for example, also provides temporary storage for the system 115.

The listener or listening module or sniffer 131 includes hardware and/or software for listening to the traffic between the respective scanner 100 and host computer 102. The listener 131 communicates with the feature extractor 133. The listener may be, for example, SandBlast Now™ listening software, from Check Point Software Technologies Ltd. of Israel, operating in the inspection server(s) 110.

The feature extractor 132 extracts various features, including data from the traffic being listened to or sniffed. Extracted features, for example, include, protocols, such as communication protocols, communication ports (source or destinations), scanned vulnerabilities, number of bytes sent and/or received, call direction and the like. The feature extractor, also extracts response codes from the host servers 102 from the traffic. The response codes are standard codes that indicate whether a request, such as a request by a scanner 100, to communicate with a host server 102, for various data associated with the host server 102, has succeeded or not succeeded. The feature extractor 132 can also assign weights to extracted features from a combination of extracted features.

The feature correlator and/or aggregator (or feature correlator and/or aggregator module) 133 creates combinations and/or weights of extracted features. These combinations of extracted features are used in vulnerability analysis, for example, when the combination of extracted features is subjected to an algorithm for analyzing and determining vulnerability of a host computer 102a-102e. The algorithms are stored in the storage media 134. Based on the feature combination, the algorithm to determine vulnerability (or nonvulnerability) is, for example, either selected by the feature correlator and/or aggregator 133, or by the CPU 120. Various feature combinations are, for example, programmed into this module 133.

The zone direction module 135, determines a zone direction by analyzing parameters, for example, the IP (Internet Protocol) address of the scanner, network subnet/net range of the scanner, or by previous knowledge of the specific network architecture, where the device being scanned resides.

Auxiliary storage media 136 is designated for storing one or more lists of vulnerable host computers and vulnerability breaches known to various external scanners, discovered by the various scans being listened to and analyzed.

A communications interface (communications module) 137 facilitates communications, including notifications of a host computer 102 being vulnerable to threats and the like, in the Enterprise Network 50 or along the WAN 55. The communications interface 137 also sends alerts to system 115 designated destinations to inform of the detected vulnerability and/or vulnerable host computer 102a-102e. This interface 137 is also for receiving communications, such as when a component of the system 115 is being programmed.

Attention is now directed to FIG. 2, formed of FIGS. 2A and 2B, which shows a flow diagram detailing computer-implemented processes and sub-processes in accordance with embodiments of the disclosed subject matter. The aforementioned process and its sub-processes are, for example, performed automatically and in real time. FIG. 2A, of blocks 200-212 shows a method for determining whether there are vulnerable hosts in an enterprise network or local area network, known to external attackers or entities. FIG. 2B of blocks 214-240 discloses a method for determining whether devices are prone to being found vulnerable.

The process begins at a START block 200, where the Inspection Server 110 is positioned between a scanner 100 and one or more host computers 102. The process moves to block 202, for the listener 131 monitors a communication session, including the two-way traffic, between a scanner 100 and a host computer 102, to determine whether the communication session or traffic is indicative of a scanning session. The listener 131 analyzes the traffic, for example, by running a software package known as Intrusion Prevention System (IPS) from checkpoint Software Technologies of Tel Aviv, Israel.

The process moves to block 204, where the system 115 determines whether there is a scanning session. If no, at block 204, the process returns to block 202, from where it resumes. If yes, at block 204, the process moves to block 206, where there is a scanning session.

At block 206, the feature extractor 132 automatically extracts features from the traffic of the scanning session. The features include, for example, protocols, such as communication protocols, ports (destinations), previously scanned vulnerabilities; number of bytes sent and/or received response codes, and the like.

The process moves to block 208, where the extracted features are correlated and/or aggregated into a combination of features, by the feature correlation and/or aggregation module 133. Based on the combination of features created by correlation and/or aggregation, the process moves to block 210. At block 210, the feature combination is analyzed to detect vulnerabilities. This analysis is performed, for example, by applying an algorithm, from the stored algorithms 134, to determine vulnerabilities, e.g., vulnerable hosts.

### Example 1

Extracted features (input for the Algorithm) are:
Port: 8080
Protocol: HTTP
Number of Bytes Received: 1024
Number of Bytes Sent: 534
Response Code: 200
Industry Reference: CVE_20XX_XXXX

The Algorithm is:

```
If (protocol = HTTP)
  Rx_Bytes_Threshold > 500
  Tx_Bytes_Threshold > 500
  Relevant_Response_Code = 200
AND
If (Number_Bytes_Received > Rx_Bytes_Threshold) AND (Number_Bytes_Sent >
Tx_Bytes_Threshold) AND (HTTP_Response_code = Relevant_Response_Code)
The host is opened to the wide network (internet) and successfully scanned for vulnerabilities of
type CVE_20XX_XXXX
If (port = 8080 AND protocol = HTTP) [YES]
  Rx_Bytes_Threshold > 500
  Tx_Bytes_Threshold > 500
  Relevant_Response_Code = 200
AND
If (Number_Bytes_Received [1024] > Rx_Bytes_Threshold [500]) [YES] AND
(Number_Bytes_Sent [536] > Tx_Bytes_Threshold [500]) [YES] AND (HTTP_Response_code
[200] = Relevant_Response_Code [200]) [YES]
There is Vulnerability [YES]
The host is opened to the wide area network (Internet) and successfully scanned for
vulnerabilities of type CVE_20XX_XXXX
```

Applying the Data (where bracketed ([ ]) items are added for understanding the analysis):

### Example 2

Extracted features (input for the Algorithm) are:
Number of Bytes Sent: 0
Number of Bytes Received: 1000
Vulnerability Name: CVExxx2012_xxx
Protocol: SIC

The Algorithm is:

If ((Number_Bytes_Sent > 512 AND Number_Bytes_Received > 512) AND (TAG:
“SIC_Server))
THEN Vulnerability = CVExxx2012_xxx)
ELSE Not Vulnerable

Applying the Data (where bracketed ([ ]) items are added for understanding the analysis):

If ((Number_Bytes_Sent [0] > 512 AND Number_Bytes_Received [1000] > 512) [NO] AND
(TAG: “SIC_Server) [YES])
THEN Vulnerability = CVExxx2012_xxx) [NO]
ELSE Not Vulnerable [YES]

Accordingly, the host computer being scanned was found not to be vulnerable.

The process moves to block 212, where it is determined whether a vulnerability was detected. If no, the process moves to block 202, from where it resumes, as detailed above. If yes at block 212, the process moves to blocks 214-240, where the detected vulnerability is subject to further analysis.

At block 214, the system 115, for example, the zone direction detector module or zone direction detector 135, determines a zone direction by analyzing parameters, for example, the IP (Internet Protocol) address of the scanner, network subnet/net range of the scanner, or by previous knowledge of the specific network architecture, where the device being scanned resides. The determined zone direction establishes whether the scanner 100 which encountered the vulnerabilities was in a trusted or untrusted zone. If the scanner was in a trusted zone, the process moves to block 220. From block 220, the process moves to block 222, where the vulnerable host computer, e.g., Host Computer 1 102a or Host Computer 2 102b from the trusted zone are found. This vulnerable host computer from the trusted zone is added to a list of vulnerable host computers, at block 224, and stored, for example, in the auxiliary storage 136. The process moves to block 240.

For example, if a scanner 100 is sitting in a trusted zone, it can be determined which host computer(s), e.g., computers 102a, 102b, were found to be vulnerable. However, it cannot be determined whether these host computer(s), e.g., 102a, 102b, are open to scanners in untrusted zones, e.g., 100b, 100c.

Returning to block 214, if the scanner was in an untrusted zone, the process moves to block 230, where the scanner was in an untrusted zone, such as the WAN 55, e.g., the Internet. From block 230, the process moves to block 232. At block 232, it is determined whether host computer is open to the Internet (an untrusted Zone). Moving to block 234, the system 115 determines whether host computers are open to scanners in untrusted zones. Next, at block 236, it is determined whether which host computer is likely vulnerable, including which specific scanner detected the vulnerability in the host and the specific vulnerability detected. The process then moves to block 240.

For example, the scanner, e.g., 100b, 100c, is sitting in an untrusted zone, for example, the WAN 55. Based on running the aforementioned algorithms, it can be determined whether there are hosts open to untrusted zones, e.g., which hosts are subject to network address translation (NAT) address changes, which vulnerability(ies) are present in the determined actual host, which scanner detected the vulnerability(ies), and the scanner location, e.g., by country or geolocation.

Returning to block 240, the data obtained from blocks 220-224 and 230-234 is stored, and based on blocks 200-212, should vulnerabilities have been found, the communications interface 137 issues an alert to the requisite destination as to the vulnerabilities. From block 240, the process returns to block 202, from where it resumes, as detailed above.

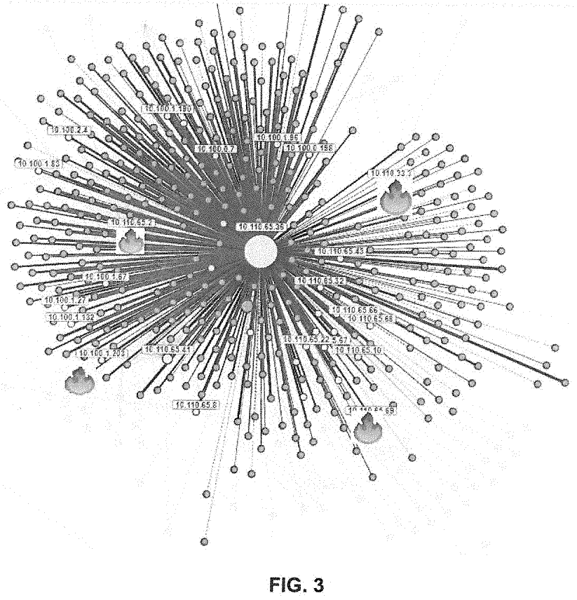

Results from blocks 224 and 234 are provided in two lists and a threat map, such as the threat map report of FIG. 3. The threat marks the vulnerable scans in the context of the enterprise network 50.

For example, hardware for performing selected tasks according to embodiments of the invention could be implemented as a chip or a circuit, or a virtual machine or virtual hardware. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. A non-transitory computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable non-transitory storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for determining vulnerabilities in devices comprising:
listening to traffic, by an inspection server, between a scanner and a host computer; and
analyzing the traffic, by the inspection server, to determine vulnerabilities in the host computer.

2. The method of claim 1, wherein the analyzing the traffic includes determining that the traffic is traffic of a scanning session.

3. The method of claim 2, wherein the analyzing the traffic includes identifying features of the scanning session traffic including, one or more of:
protocols;
source communication ports;
destination communication ports;
scanned vulnerabilities;
number of bytes sent;
number of bytes received;
call direction; and,
response codes.

4. The method of claim 3, wherein the protocols include communication protocols.

5. The method of claim 3, wherein the analyzing the traffic of the scanning session includes selecting one or more of the identified features from the scanning session traffic.

6. The method of claim 5, wherein the analyzing the traffic of the scanning session additionally comprises:
applying an algorithm to the selected one or more identified features to determine whether there are vulnerabilities in the devices.

7. The method of claim 6, wherein the vulnerabilities include known vulnerabilities.

8. The method of claim 7, wherein the devices include host computers.

9. A method for detecting the location of vulnerabilities in devices along a network, comprising:
determining the existence of vulnerabilities in at least one device from the traffic of a scanning session;
determining the zone direction of the scanner that detected the vulnerability, the zone direction including one of a trusted zone or an untrusted zone.

10. The method of claim 9, wherein the zone direction is determined based on one or more parameters including:
Internet Protocol (IP) address of a scanner;
network subnet/net range of the scanner; or,
knowledge of the network architecture associated with the device being scanned resides in a trusted or untrusted zone.

11. The method of claim 10, wherein if the scanner resides in an untrusted zone, the device being scanned is open to vulnerabilities outside of the trusted zone.

12. The method of claim 11, wherein outside of the trusted zone includes the Internet.

13. The method of claim 10, wherein if the scanner resides in a trusted zone, the device being scanned can be identified as being open to vulnerabilities.

14. A system for determining vulnerabilities in devices comprising:
a memory;
a processor coupled to the memory, the processor programmed with executable instructions to determine whether detected traffic is that of a scanning session and if so, determining vulnerabilities in devices;
a listener for listening to the traffic of the scanning session;
a feature extractor for extracting features from the traffic of the scanning session; and,
a feature aggregator for selecting extracted features and applying an algorithm for the features to detect vulnerabilities in the devices.

15. The system of claim 14, wherein the extracted features include one or more of:
protocols;
source communication ports;
destination communication ports;
scanned vulnerabilities;
number of bytes sent;
number of bytes received;
call direction; and,
response codes.

16. The system of claim 14, additionally comprising: a zone direction detector for detecting the zone direction of a scanner associated with the scanning session for the traffic.

17. The system of claim 16, wherein the zone direction detector analyzes parameters including one or more of: the Internet Protocol (IP) address of the scanner, network subnet/net range of the scanner, or, previous knowledge of the specific network architecture of where the device being scanned resides.
